(19) United States
(12) Patent Application Publication
(10) Pub. No.: US 2005/0276695 A1
(43) Pub. Date: Dec. 15, 2005

(54) Electric fan with a sensor

(76) Inventor: Tai-Ching Lee, Tainan (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/863,472

(22) Filed: Jun. 9, 2004

(51) Int. Cl. F03D 11/00

(52) U.S. Cl. 416/5

(57) ABSTRACT

An electric fan with a sensor includes a sensor, a control chip, a light control unit, a light sensor and a power control unit. The sensor is connected with the control chip. The control chip is connected with the light control unit. The light control unit includes illuminating devices corresponding to the light sensor. The light sensor is connected with the power control unit. The power control unit includes a power supply. When the sensor is activated and outputs a signal to the control chip which then controls the light control unit to activate the illuminate devices to illuminate. The light sensor sends a signal to the power control unit to change the output of a power supply, so as to vary the speed of the fan.

### FIELD OF THE INVENTION

This invention relates to an electric fan with a sensor, and more particularly to a sensor is activated by a temperature change or an odor smell detected to vary the speed of the fan.

### DESCRIPTION OF THE PRIOR ART

A conventional electric fan comprises a speed adjustment, which requires a user to switch by hand or through a remote controller. In many circumstances, a room is filled with cigarette smoke or human body odor before people sense these and turn on the fan.

In view of this and many other shortcomings, the inventor has derived the present invention to improve the shortcomings.

### SUMMARY OF THE INVENTION

It is the primary objective of the present invention to provide an electric fan with a sensor, which uses a sensor to control the fan speed.

It is another objective of the present invention to provide an electric fan with a sensor, which maintains a clean and healthy room atmosphere.

It is a further objective of the present invention to provide an electric fan with a sensor, which controls the fan automatically.

### BRIEF DESCRIPTION OF THE DRAWINGS

FIG. 1 is a block diagram of the present invention;

FIG. 2 is a schematic diagram of the electric circuitry of the present invention, and

FIG. 3 is a schematic diagram of another electric circuitry of the present invention.

### DETAILED DESCRIPTION OF THE PREFERRED EMBODIMENT

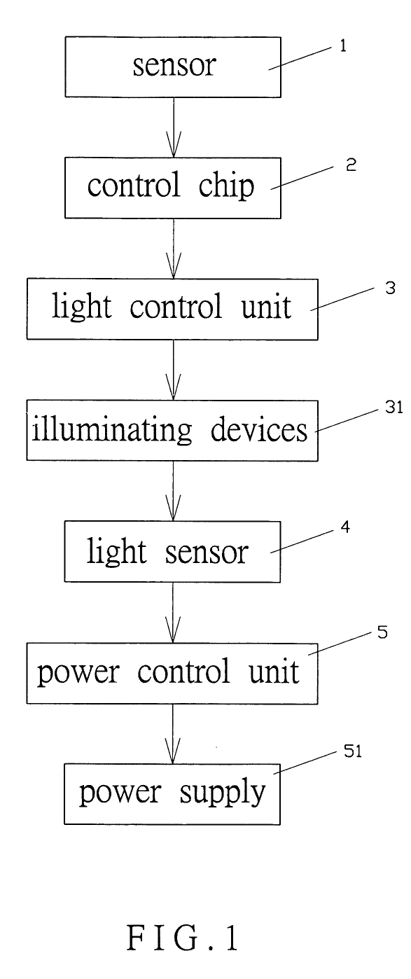

As shown in FIG. 1, the present invention comprises a sensor 1, a control chip 2, a light control unit 3, a light sensor 4, and a power control unit 5.

The sensor 1 is connected with the control chip 2. The control chip 2 is connected with the light control unit 3. The light control unit 3 includes illuminating devices 31 corresponding to the light sensor 4. The light sensor 4 is connected with the power control unit 5. The power control unit 5 includes a power supply 51.

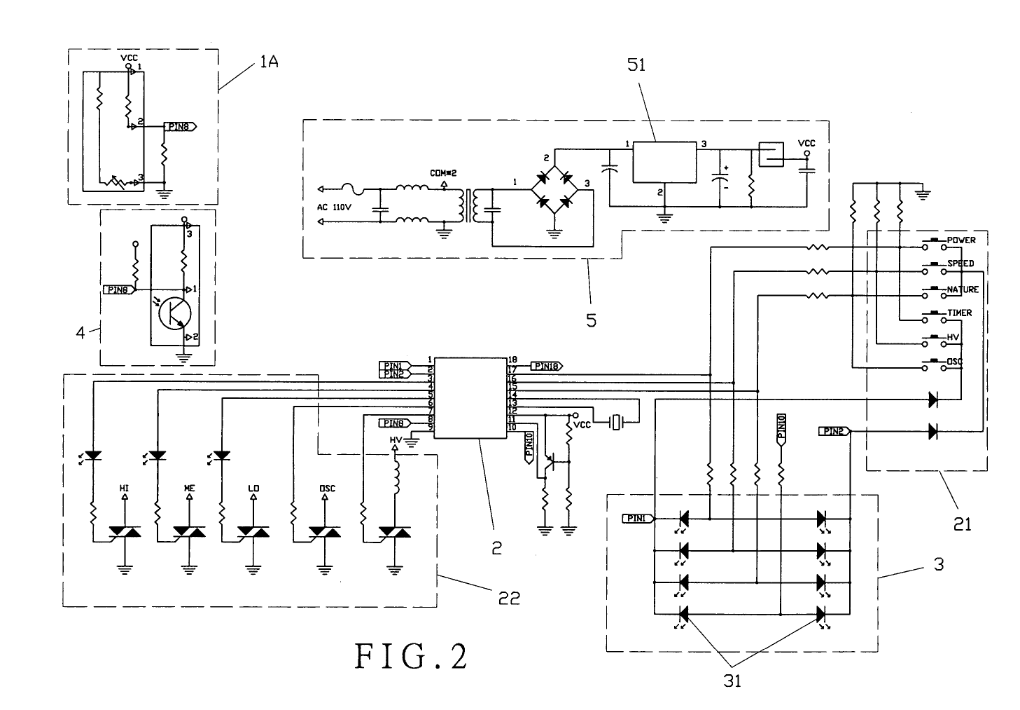

As shown in FIG. 2, the sensor 1 may be a temperature sensor 1A to detect a temperature change. It sends a signal to trigger the control chip 2 which then activates the illuminating devices 31 of the light control unit 3 to illuminate. When receiving the light sources from the illuminating devices 31, the light sensor 4 sends a signal to the power control unit 5. The power control unit 5 changes the output of the power supply 51 to vary the speed of a fan. The control chip 2 comprises a switch 21 and a display 22 for a user to receive the controlling status.

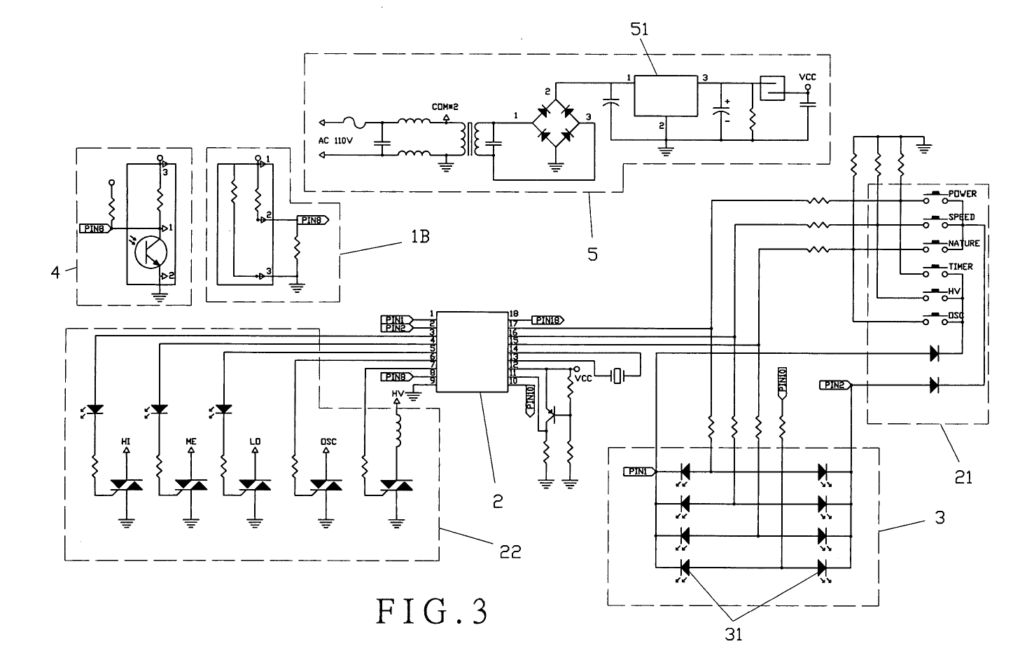

The sensor 1 may be a smell sensor 1B, as shown in FIG. 3. When the smell sensor 1B detects an abnormal odor, it sends a signal to the control chip 2. The control chip 2 in turn sends a signal to the light control unit 3 to trigger the illuminating devices 31 to illuminate. When receiving the light sources from the illuminating devices 31, the light sensor 4 sends a signal to the power control unit 5. The power control unit 5 then changes the output of the power supply 51 to vary the speed of the fan. The switch 21 and the display 22 are always connected to the control chip 2 to show the controlling status of the fan.

1. An electric fan with a sensor comprising a sensor, a control chip, a light control unit, a light sensor, and a power control unit, said sensor being connected with said control chip, said control chip being connected with said light control unit, said light control unit comprising illuminating devices, said illuminating devices corresponding to said light sensor, said light sensor being connected with said power control unit, said power control unit comprising a power supply, said sensor sending a signal to said control chip, said control chip then sending a signal to said light control unit to trigger said illuminating devices to illuminate, said light sensor sensing light sources from said illuminating devices of said light control unit and outputting a signal to said power control unit to change the output of said power supply to vary the speed of said fan.

2. The electric fan with a sensor, as recited in claim 1, wherein said sensor is a temperature sensor.

3. The electric fan with a sensor, as recited in claim 1, wherein said sensor is a smell sensor.
